(19) United States
(12) Patent Application Publication
(10) Pub. No.: US 2005/0212174 A1
(43) Pub. Date: Sep. 29, 2005

(54) Method for manufacturing chemical filter

(75) Inventors: Takashi Tanahashi, Yokohama-shi (JP); Toshiro Nakano, Yokohama-shi (JP); Akihiro Imai, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NICHIAS Corporation, Tokyo (JP)

(21) Appl. No.: 11/032,033

(22) Filed: Jan. 11, 2005

(30) Foreign Application Priority Data
Mar. 29, 2004 (JP) 2004-096717

(51) Int. Cl. B29C 53/00

(52) U.S. Cl. 264/286

(57) ABSTRACT

A method for manufacturing a chemical filter with a corrugated honeycomb structure is disclosed. The method comprises coating or impregnating a fibrous paper containing ion-exchange fiber with a slurry mixture of an ion-exchange resin powder and an adhesive to obtain a paper supporting ion-exchange resin powder and applying the paper supporting ion-exchange resin powder to a corrugating process.

### TECHNICAL FIELD

The present invention relates to a method for manufacturing a chemical filter for cleaning air used in clean rooms and apparatuses in facilities for manufacturing semiconductors, liquid crystals, and precision electronic parts in which ionized gaseous pollutants are produced by eliminating ionized gaseous pollutants.

### BACKGROUND ART

In frontier industries such as the semiconductor manufacturing industry and liquid crystal manufacturing industry, controlling pollution of the air and product surfaces in clean rooms is important to ensure a high yield, high quality, and reliability of the products. In the semiconductor manufacturing industry, in particular, as the degree of integration of the products increases, control of ionized gaseous pollutants has become indispensable in addition to the control of particulate matters using a HEPA filter, ULPA, and the like.

The ionized gaseous pollutants include basic gases and acidic gases. Of these gases, the basic gases such as ammonia are known to adversely affect resolution during the step of exposure to radiation and cause wafer surfaces to become clouded in the manufacture of semiconductor devices. SOₓ, which is an acidic gas, produces lamination defects in substrates in the thermal oxidation membrane-forming process during manufacture of semiconductors, whereby the characteristics and reliability of the semiconductor devices are adversely affected.

Since ionized gaseous pollutants cause various problems in semiconductor manufacturing processes and the like in this manner, the concentration of the ionized gaseous pollutants in a clean room used in semiconductor manufacturing and the like is desired to be several μg/m³ or less.

A conventional practice for removing the ionized gaseous pollutants has been to introduce ion-exchange groups into a chemical filter. Japanese Patent Application Laid-open No. 2001-259339 (Patent Document 1) discloses an air filter material in the form of paper comprising a matrix and powder of ion-exchange resin having a particle size and ion-exchange capacity in specific ranges incorporated into the matrix. Japanese Patent Application Laid-open No. 2000-5544 (Patent Document 2) discloses a deodorant comprising an adsorption medium and an ion-exchange resin. Japanese Patent Application Laid-open No. 2003-10613 (Patent Document 3) discloses an air filter medium for filtering ionized alkaline gases, wherein the substrate of the filter medium contains fine particles, granules, or fiber made of a cation-exchange resin, on which phosphoric acid is supported.

In addition to the initial target performance of eliminating ionized gaseous pollutants to a concentration of several μg/m³, the air filter is required to possess excellent durability, specifically, to exhibit elimination performance for a long period of time. Therefore, a large amount of ion-exchange resin must be introduced to increase the ion-exchange capacity per unit volume of the chemical filter.

However, in the air filter material described in Japanese Patent Application Laid-open No. 2001-259339, if a large amount of fine particles of ion-exchange resin is attached to the pulp matrix, the fine particles of ion-exchange resin are easily detached from the matrix because the fine particles are supported on the surface of the matrix by means of an electrostatic force or frictional force between the pulp matrix and the fine particles of ion-exchange resin. The deodorant described in Japanese Patent Application Laid-open No. 2000-5544 comprises a mixture of activated carbon and an ion-exchange resin milled into paper. Since an increased amount of the ion-exchange resin mixed with activated carbon unduly impairs the strength of the resulting deodorant obtained by paper-milling, the deodorant may collapse during aeration or the milling of paper is impossible. The air filter material described in Japanese Patent Application Laid-open No. 2003-10613 has the same problem of difficulty in incorporating a large amount of ion-exchange resin into the filter substrate as the deodorant of the Japanese Patent Application Laid-open No. 2000-5544. In addition, since the filter material eliminates ionized gaseous pollutants by the neutralization reaction of phosphoric acid supported on the air filter with the ionized gaseous pollutants, the salt generated by the neutralization reaction may inhibit processed gas from diffusing in spaces in filter fibers, which results in a decrease in the life of the filter material.

An object of the present invention is, therefore, to provide a method for manufacturing a chemical filter exhibiting remarkably improved capability of removing ionized gaseous pollutants by causing a large amount of ion-exchange resin powder to be supported on a substrate containing ion-exchange fiber, wherein ion-exchange resin powder particles detach only with difficulty and the chemical filter has only a small pressure loss.

### DISCLOSURE OF THE INVENTION

As a result of extensive studies to achieve the above object, the inventors of the present invention have found that if a paper supporting ion-exchange resin powder is obtained by coating or impregnating a fibrous paper containing ion-exchange fiber with a slurry mixture of an ion-exchange resin powder and an adhesive and a chemical filter with a corrugated honeycomb structure is formed from the paper supporting the ion-exchange resin powder, a large amount of ion-exchange resin powder can be supported even in the fiber voids of the fibrous paper which forms the chemical filter. This finding has led to the completion of the present invention.

Specifically, the present invention (1) provides a method for manufacturing a chemical filter with a corrugated honeycomb structure, comprising coating or impregnating a fibrous paper containing ion-exchange fiber with a slurry mixture of an ion-exchange resin powder and an adhesive to obtain a paper supporting an ion-exchange resin powder and applying the paper supporting an ion-exchange resin powder to a corrugating process.

The present invention (2) provides a method for manufacturing the above chemical filter comprising applying the above slurry mixture to both sides of the above fibrous paper containing ion-exchange fiber.

The present invention (3) provides a method for manufacturing the above chemical filter, wherein the above fibrous paper contains 20-80% of ion-exchange fiber.

The present invention (4) provides a method for manufacturing the above chemical filter, wherein the ion-exchange capacity of the ion-exchange fiber is 1-5 meq/g.

The present invention (5) provides a method for manufacturing the above chemical filter, wherein the above ion-exchange fiber contains at least a cation-exchange fiber or an anion-exchange fiber.

The present invention (6) provides a method for manufacturing the above chemical filter, wherein the ion-exchange resin powder particles have an average diameter of 1-150 μm.

The present invention (7) provides a method for manufacturing the above chemical filter, wherein the ion-exchange capacity of the ion-exchange resin powder is 1-10 meq/g.

The present invention (8) provides a method for manufacturing the above chemical filter, wherein the above ion-exchange resin powder contains at least a cation-exchange resin powder or an anion-exchange resin powder.

The present invention (9) provides a method for manufacturing the above chemical filter, wherein the above adhesive comprises at least one of inorganic adhesives or organic adhesives.

Since the ion-exchange fiber combines with ion-exchange resin powder by a hydrogen bond in the method for manufacturing the chemical filter of the present invention (1), it is possible to cause a large amount of ion-exchange resin powder to be supported on the outside surface as well as in fiber voids of the fibrous paper containing ion-exchange fiber without being detached. The ion-exchange resin powder does not detach even after forming and processing afterward. For this reason, it is possible to significantly increase the amount of ionized gaseous pollutants reacted per unit volume of the chemical filter and to increase the life of the chemical filter to eliminate the ionized gaseous pollutants. In addition, since the resulting chemical filter has a corrugated honeycomb substrate which allows the flow path for the process air to run parallel to the airflow direction, pressure loss can be reduced. Therefore, it is possible to employ compact peripheral equipment and reduce costs. Furthermore, when causing an ion-exchange resin powder to be supported on the fibrous paper before forming the chemical filter with a corrugated honeycomb structure, it is possible to adjust the type of the ion-exchange resin powder and the amount to be supported on each side of the fibrous paper. Moreover, because the slurry mixture can sufficiently permeate into fiber voids using the method for manufacturing the chemical filter of the present invention (2), the amount of the ion-exchange-resin powder supported can be increased. According to the method for manufacturing the chemical filter of the present invention (3), (4), or (7), the amount of ionized gaseous pollutants reacted per unit volume of the filter can be increased. According to the method for manufacturing the chemical filter of the present invention (5) or (8), a chemical filter that can remove both basic gases (ammonia, amines, etc.) and acidic gases (SOₓ, NOₓ, etc.) can be obtained. According to the method for manufacturing the chemical filter of the present invention (6), adhesion of ion-exchange resin powder to the fibrous paper can be increased, whereby it is possible to reduce detachment of ion-exchange resin powder from the substrate. According to the method for manufacturing the chemical filter of the present invention (9), the ion-exchange resin powder can be firmly supported even in the fiber voids of the fibrous paper.

### BRIEF DESCRIPTION OF THE DRAWINGS

FIG. 1 is a drawing for illustrating the method for manufacturing the paper supporting ion-exchange resin powder of the present invention.

FIG. 2 is another drawing for illustrating the method for manufacturing the paper supporting ion-exchange resin powder of the present invention.

FIG. 3 is a drawing for illustrating the corrugated honeycomb structure of the chemical filter of the present invention.

FIG. 4 shows a cross-sectional view of a part of the corrugated honeycomb structure of the chemical filter of the present invention.

FIG. 5 is a graph showing the change over time of the ammonia gas removal rate.

### DETAILED DESCRIPTION

The fibrous paper containing ion-exchange fiber used in the present invention is a woven fabric or nonwoven fabric formed from ion-exchange fiber and other reinforcing fibers. Either cation-exchange fiber or anion-exchange fiber can be used as the ion-exchange fiber without any specific limitation. As the cation-exchange fiber, strongly acidic cation-exchange fiber, weakly acidic cation-exchange fiber, and the like can be mentioned. As the ion-exchange group introduced into the cation-exchange fiber, a sulfonic acid group, phosphonic acid group, carboxylic acid group, and the like can be given. As the anion-exchange fiber, strongly basic anion-exchange fiber, weakly basic anion-exchange fiber, and the like can be mentioned. As the ion-exchange group introduced into the anion-exchange fiber, a trimethyl ammonium group, dimethylethanol ammonium group, and the like can be given. As the material for the ion-exchange fiber, polystyrene fiber, polyacrylonitrile fiber, polyvinyl-alcohol fiber, and the like can be given without any specific limitation. The ion-exchange fiber used in the present invention may be a single ion-exchange fiber, a combination of two or more types of cation-exchange fiber, a combination of two or more types of anion-exchange fibers, or a combination of cation-exchange fiber and anion-exchange fiber.

The amount of the ion-exchange fiber in the fibrous paper is 20-80 wt %, and preferably 40-60 wt %. If the amount is less than 20 wt %, the force of the chemical filter for drawing the ion-exchange resin powder due to the hydrogen bond is weak, giving rise to easy desorption of ion-exchange resin powder. In addition, capability of the chemical filter to eliminate ionized gaseous pollutants is impaired. If the amount exceeds 80 wt %, the mechanical strength of the resulting fibrous paper decreases due to low mechanical strength of the ion-exchange fiber.

There are no specific limitations to the ion-exchange capacity of the ion-exchange fiber. The ion-exchange capacity is preferably 1-5 meq/g, and still more preferably 2-4 meq/g. If the ion-exchange capacity is less than 1 meq/g, the force of the chemical filter for drawing the ion-exchange resin powder is weak, giving rise to easy desorption of the ion-exchange resin powder. In addition, capability of the chemical filter to eliminate ionized gaseous pollutants is impaired. If the ion-exchange capacity is more than 5 meq/g, mechanical strength of the resulting fibrous paper decreases due to an unduly decrease in the mechanical strength of the ion-exchange fiber.

Although there are no specific limitations, the average fiber diameter of the ion-exchange fiber is preferably 1-100 μm, and still more preferably 10-50 μm. Although there are no specific limitations, the average fiber length of the ion-exchange fiber is preferably 0.1-50 mm, and still more preferably 1-10 mm.

Ion-exchange fiber containing at least one of cation-exchange fiber and anion-exchange fiber is preferable because of the capability of removing basic gas (ammonia, amines, etc.) or acidic gas (SOₓ, NOₓ, etc.), or both basic gas and acidic gas.

Any reinforcing fibers that can be commonly used for the manufacture of chemical filters can be used without any specific limitation. Inorganic reinforcing fibers such as silica alumina fiber, silica fiber, alumina fiber, mullite fiber, glass fiber, rock wool fiber, and carbon fiber; and

organic reinforcing fibers such as polyethylene fiber, polypropylene fiber, nylon fiber, polyester fiber, polyvinyl alcohol fiber, aramid fiber, pulp fiber, and rayon fiber can be given as examples. These reinforcing fibers may be used either individually or in combination of two or more. A combination of inorganic fiber and organic fiber is preferable to increase the mechanical strength of the chemical filter. A combination of silica alumina fiber and rayon fiber is particularly preferable.

Although there are no specific limitations, the average diameter of the reinforcing fiber is preferably in the range of 0.1-25 μm, and more preferably 0.5-10 μm, and the average fiber length is usually in the range of 0.1-50 mm, and preferably 10-20 mm. The average diameter and length of the reinforcing fiber in the above range can increase the mechanical strength of the fibrous paper.

Although there are no specific limitations, the fiber void ratio of the fibrous paper is preferably 50-95%, and particularly preferably 70-95%. The fiber void ratio herein refers to the value obtained by dividing the total volume of voids in fibers forming the above woven or nonwoven fabric by the apparent volume of the woven or nonwoven fabric. The fiber void ratio in the above range ensures ion-exchange resin powder to be supported not only on the outside surface of the fibrous paper, but also in the fiber voids, whereby the amount of the ion-exchange resin powder supported on the fiber supporting body increases. Although there are no specific limitations, the thickness of the woven or nonwoven fabric is preferably 0.1-0.5 mm, and still more preferably 0.2-0.3 mm. The thickness in the above range increases the mechanical strength of the fibrous paper and the amount of ion-exchange resin powder supported in the fiber void of the fibrous paper.

In the present invention, the fibrous paper is coated or impregnated with a slurry mixture of ion-exchange resin powder and an adhesive. Either cation-exchange resin powder or anion-exchange resin powder can be used as the ion-exchange resin powder without any specific limitation. As the cation-exchange resin powder, strongly acidic cation-exchange resin powder, weakly acidic cation-exchange resin powder, and the like can be mentioned. As the anion-exchange resin powder, strongly basic anion-exchange resin powder, weakly basic anion-exchange resin powder, and the like can be mentioned. The same ion-exchange groups and materials for ion-exchange resin powder as previously mentioned for the ion-exchange fibers can be given as those to be introduced into or used for the cation-exchange resin powder or the anion-exchange resin powder. The ion-exchange resin powder used in the present invention may be a single ion-exchange resin powder, a combination of two or more types of cation-exchange resin powder, a combination of two or more types of anion-exchange resin powder, or a combination of cation-exchange resin powder and anion-exchange resin powder.

The ion-exchange resin powder used in the present invention has an average diameter usually of 1-150 μm, and preferably 10-50 μm. If the average diameter is more than 150 μm, the weight of each particle is too large to have sufficient adhesion strength with an adhesive, which may result in detachment of the ion-exchange resin powder. If the average diameter is less than 1 μm, the slurry mixture of the ion-exchange resin powder and the adhesive has too large a viscosity making it difficult to obtain fibrous paper sufficiently impregnated with the slurry mixture by coating.

Only a small amount of the ion-exchange resin powder can be supported on the fibrous paper.

The ion-exchange resin powder has an ion-exchange capacity usually of 1-10 meq/g, and preferably 3-6 meq/g. If the ion-exchange capacity is less than 1 meq/g, the ion-exchange resin powder exhibits only insufficient reactivity with ionized gaseous pollutants and its performance in removing the ionized gaseous pollutants tends to decrease. If the ion-exchange capacity is more than 10 meq/g, the ion-exchange resin forming the ion-exchange resin powder has only poor chemical stability and the ion-exchange groups tend to release from the ion-exchange resin powder.

Ion-exchange resin powder containing both cation-exchange resin powder and anion-exchange resin powder is preferable because of the capability of removing both basic gases (ammonia, amines, etc.) and acidic gases (SOₓ, NOₓ, etc.).

When the ion-exchange resin powder contains both cation-exchange resin powder and anion-exchange resin powder, their mixing ratio by weight is 2:8 to 8:2, and preferably 4:6 to 6:4. If the weight ratio is outside the above range, either the performance of the chemical filter to eliminate basic gases or the performance to eliminate acidic gases tends to decrease.

There are no specific limitations to the adhesive used in the present invention. Inorganic adhesives and organic adhesives can be given as examples. An adhesive containing either an inorganic adhesive or an organic adhesive is sufficient for use in the present invention. As the inorganic adhesive, silica sol, alumina sol, titania sol, sodium silicate, potassium silicate, and the like can be given. As the organic adhesive, acrylic resin, vinyl-acetate resin, epoxy resin, phenol resin, silicone resin, their copolymer resins, and the like can be given. Of these, inorganic adhesives are preferable because the cured products of the inorganic adhesives do not produce films but produce aggregrates which provide spaces through which ionized gaseous pollutants can easily permeate and be removed at a high rate.

The slurry mixture used in the present invention can be obtained by mixing the ion-exchange resin powder, the adhesive, and water. A surfactant such as a dispersant can be optionally added. When an adhesive containing water is used, the water in the adhesive may be used as the water for the slurry mixture, although water may be separately added to the slurry mixture. For example, when the adhesive is silica sol, water other than that in the silica sol can be used as the water forming the slurry mixture. When the adhesive is an inorganic adhesive, the ratio by weight of the ion-exchange resin powder and the inorganic adhesive is 90:10 to 50:50, and preferably 85:15 to 75:25. When the adhesive is an organic adhesive, the ratio by weight of the ion-exchange resin powder and the organic adhesive is 99:1 to 80:20, and preferably 95:5 to 85:15. The concentration of the slurry mixture, specifically, the ratio of the total weight of solid components in the ion-exchange resin powder and adhesive to the total weight of the slurry mixture is usually 30-70 wt %, and preferably 40-60 wt %. The mixing ratio and the concentration of the slurry mixture in the above ranges can cause the ion-exchange resin powder in the slurry mixture to be sufficiently supported by the surface and the inside of the fibrous paper by coating or impregnation.

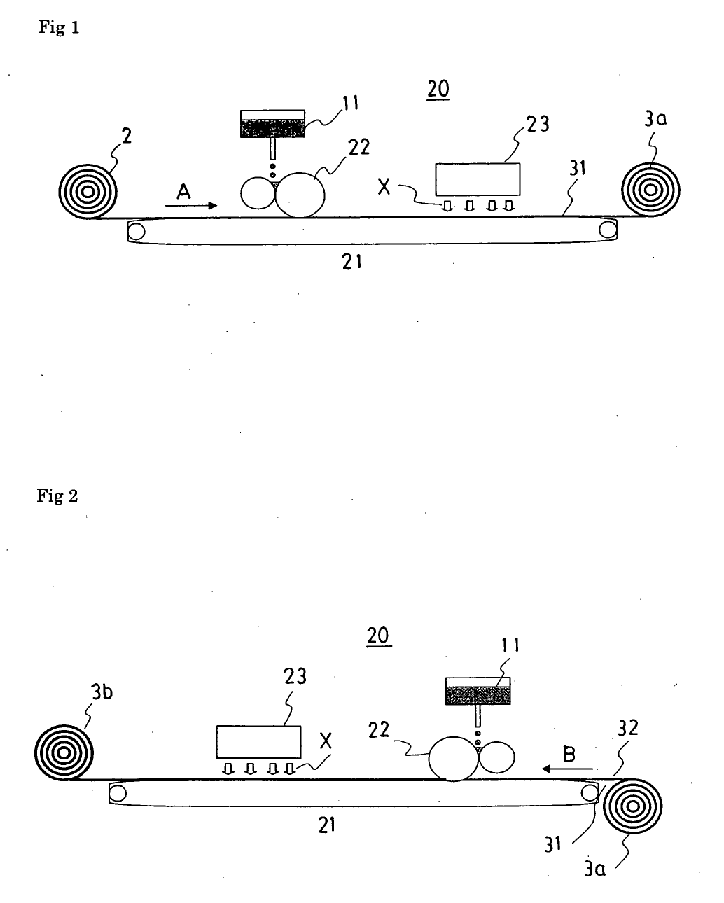

As examples of the method for coating or impregnating the fibrous paper with the slurry mixture, a method of applying the slurry mixture using a roll coater and a method of dipping the fibrous paper into the slurry mixture can be given. Of these methods, the former method is preferable, because it is easy to continuously cause the ion-exchange resin powder to be supported on the outside surface as well as inside the fibrous paper. As a specific example of the former method, a method of using a coating apparatus 20 shown in FIGS. 1 can be given. A slurry mixture 11 is applied onto a flat fibrous paper 2 conveyed on a conveyor belt 21 using a roll coater 22 (one-side coating method). A fibrous paper with the ion-exchange resin powder supported on the outside surface or fiber voids of the fibrous paper can be obtained by coating the fibrous paper with a slurry mixture in this manner.

If necessary, the coating treatment may be carried out two or more times. For example, if the ion exchange resin powder in a slurry mixture does not sufficiently permeate into fiber voids of the fibrous paper due to a high slurry concentration or the like when coating the slurry mixture to one of the surfaces of the fibrous paper, the slurry mixture may be further coated onto the other side of the fibrous paper (both side coating method).

The both side coating method is explained referring to FIG. 1 and FIG. 2. In a coating apparatus 20 shown in FIG. 1, as a flat fibrous paper 2 on a conveyor belt 21 is continuously moved in the direction of an arrow A, a slurry mixture 11 is applied onto the upper surface 31 of the flat fibrous paper 2 and dried to obtain a paper 3a with an ion-exchange resin powder supported on one side of the flat fibrous paper 2. Next, as shown in FIG. 2, the paper 3a with an ion-exchange resin powder supported on one side is set upside down in the coating apparatus 20 as that shown in FIG. 1 (i.e., with the coated side 31 facing down and the uncoated surface facing up) and continuously moved in the direction of an arrow B. A slurry mixture 11 is applied onto the uncoated surface 32 and dried in the same manner as shown in FIG. 1 to obtain a paper 3b with an ion-exchange resin powder supported on both sides of the flat fibrous paper 2. A paper supporting ion-exchange resin powder with the ion-exchange resin powder supported on the outside surfaces and fiber voids of a fibrous paper can be obtained by coating the both sides of the fibrous paper with a slurry mixture in this manner.

The drying treatment after coating the fibrous paper 2 with the slurry mixture can be optionally applied. The drying treatment is preferable for causing the ion-exchange resin powder to be rapidly and reliably supported on the outside surface as well as in the fiber voids of the fibrous paper with the adhesive contained in the slurry mixture. As an example of the drying method, a method of heating the fibrous paper or blowing hot air onto the fibrous paper from a dryer 23 in the direction shown by an arrow X in FIGS. 1 and 2 can be given. Although there are no specific limitations, the drying treatment is carried out usually at a temperature of 50-130° C. for 5-30 minutes. When the coating treatment is carried out two or more times, it is desirable to dry the product each time the fibrous paper is coated, because an increased amount of the ion-exchange resin powder can be caused to be supported in a subsequent coating treatment implemented after causing the ion-exchange resin powder to be firmly supported by a drying treatment.

In the present invention, the chemical filter with a corrugated honeycomb structure is obtained by forming the paper supporting ion-exchange resin powder. First, a flat paper supporting ion-exchange resin powder is prepared. Next, the flat paper supporting ion-exchange resin powder is divided into a portion to be corrugated and a portion not to be corrugated. The corrugated paper is hereinafter referred to as a corrugated paper supporting ion-exchange resin powder. Corrugating is a process for fabricating a flat material such as a flat paper supporting ion-exchange resin powder into a waveform shape by passing the flat paper through a pair of upper and lower corrugated rolls. Next, a chemical filter with a corrugated honeycomb structure is prepared by alternately laminating the flat paper supporting ion-exchange resin powder and the corrugated paper supporting ion-exchange resin powder using the corrugated paper as a core.

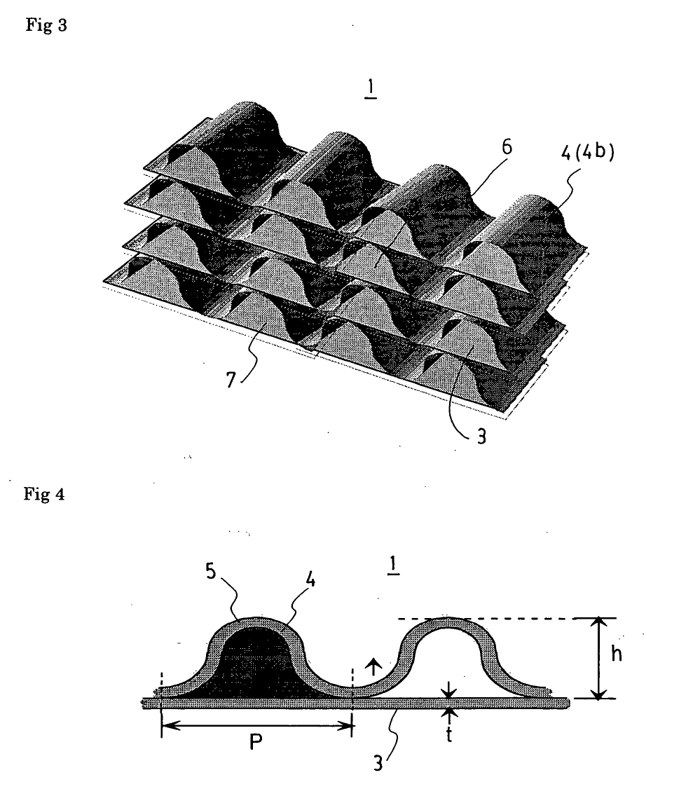

The chemical filter with a corrugated honeycomb structure will be explained using FIG. 3. FIG. 3 shows a perspective view for illustrating the corrugated honeycomb structure of the chemical filter obtained in the present invention. The chemical filter 1 with a corrugated honeycomb structure can be formed by integrating the corrugated paper supporting ion-exchange resin powder 4 (the core) and the flat paper supporting ion-exchange resin powder 3 by causing upper mountains 5 and lower mountains 5 on the corrugated paper 4 to adhere to the flat paper 3 using an adhesive, or by securing a laminated body of the flat papers 3 and the corrugated papers 4 in a frame without adherence. When an adhesive is used for lamination, the same type of inorganic adhesives as those mentioned above such as silica sol can be used.

The chemical filter I prepared in this manner has a nearly half-cylindrical cave 6 extending in the direction of the continuous mountain 5 of the corrugated paper 4 supporting ion-exchange resin powder formed between the flat paper 3 supporting ion-exchange resin powder and the corrugated fibrous paper 4 supporting ion-exchange resin powder. Therefore, the processed air introduced from an opening 7 can pass through the cave 6.

FIG. 4 is a schematic cross-sectional view of the chemical filter 1 with a corrugated honeycomb structure along the plane parallel to the opening 7. The height of the mountains h of the chemical filter 1 having a corrugated honeycomb structure is usually 0.5-10 mm, preferably 1-5 mm, and particularly preferably 1-2 mm. The pitch of the mountains p of the chemical filter 1 having a corrugated honeycomb structure is usually 1-20 mm, preferably 1-5 mm, and particularly preferably 2-4 mm. The mountain height and the pitch in the above ranges are preferable to maintain a good balance between ionic gaseous pollutant removal efficiency and pressure loss.

Because the chemical filter of the present invention contains ion-exchange fiber in the fibrous paper and the ion-exchange resin powder is caused to be supported on the surfaces as well as in the fiber voids of the fibrous paper using an adhesive, the chemical filter has a large ion exchange capacity per unit volume, a long life, and a small pressure loss. The ion exchange capacity per unit volume can be 750 eq/m³ or more, for example.

The chemical filter of the present invention can be used as a chemical filter for cleaning air in clean rooms and apparatuses in which ionized gaseous pollutants are produced in plants and the like for manufacturing semiconductors, liquid crystals, and precision electronic parts, particularly in a chemical filter for reducing the concentration of ionized gaseous pollutants to 1 μg/cm³ or less.

### EXAMPLES

The present invention will be described in more detail by examples, which should not be construed as limiting the present invention.

### Example 1

(Preparation of Slurry Mixture)

A slurry mixture 11 with a solid content (slurry concentration) of 40 wt % was prepared by mixing strongly acidic cation-exchange resin powder with an average particle diameter of 20 μm and an ion-exchange capacity of 5.0 meq/g (DIAION manufactured by Mitsubishi Chemical Corp.) and silica sol (adhesive) in a proportion to make the ratio of the solid components of the cation-exchange resin powder and silica sol 8:2.

### (Preparation of Chemical Filter with Corrugated Honeycomb Structure)

A mixture of strongly acidic cation exchange fiber with an ion exchange capacity of 2.0 meq/g (average fiber diameter: 30 μm, average fiber length: 5 mm), silica alumina fiber (average fiber diameter: 5 μm, average fiber length: 20 mm), and rayon fiber at a ratio of 50:30:20 was milled into paper by a wet milling process to obtain a flat fibrous paper with a fiber void ratio of 90% and a thickness t of 0.2 mm. The slurry mixture 11 was applied to the upper surface of the fibrous paper 2 using a roll coater 22. After drying in a dryer 23 at 80° C., a flat paper 3a with ion-exchange resin powder on one side of the flat fibrous paper 2 was rolled up (FIG. 1). Next, the flat paper 3a coated with the ion-exchange resin powder on one side was set with the coated surface facing down to apply the slurry mixture 11 to the uncoated upper surface in the same manner as above, followed by drying. Then, a flat paper 3b with the ion-exchange resin powder on the both sides of the flat fibrous paper was rolled up (FIG. 2).

A part of the flat paper 3b with the ion-exchange resin powder attached to the both sides was passed through a pair of upper and lower corrugated rolls to prepare a waveform paper 4b coated with the ion-exchange resin powder on both sides, which is to be used as a core. After applying silica sol to the mountain parts of the core 4b as an adhesive, the above flat fibrous paper 3b coated with the ion-exchange resin powder on both sides was superposed and laminated. The core and the flat fibrous paper 3b with the ion-exchange resin powder on both sides were laminated in turn in the manner such that the air passages of the cores are aligned in the same direction, thereby obtaining a corrugated honeycomb structural body shown in FIG. 3 and FIG. 4 with a core pitch p of 2.8 mm and a mountain height h of 1.3 mm.

(Preparation of Chemical Filter)

The chemical filter with a corrugated honeycomb structure thus obtained was cut to a size of 100 mm (length)×100 mm (width)×40 mm (thickness) and inserted into an aluminum frame as an ion-exchange chemical filter. The ion exchange capacity per unit volume of the chemical filter was 900 eq/m³ and the amounts of the ion-exchange fiber and the ion-exchange resin powder per unit volume of the chemical filter were respectively 60 kg/m³ and 156 kg/m³. The ion exchange capacity per unit volume was determined by multiplying the weight of the ion-exchange fiber or ion-exchange resin powder in the filter by the ion exchange capacity respectively of the ion-exchange fiber and the ion-exchange resin powder.

(Measurement of Properties)

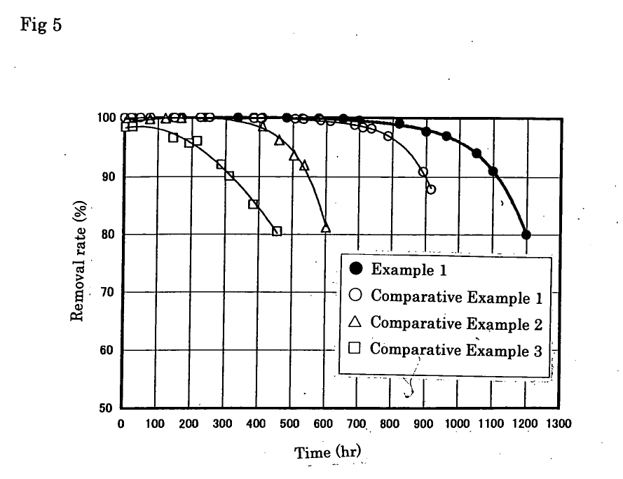

The change in the ammonia removal rate over time and the life of the chemical filter were determined under the following conditions. Although the ammonia concentration causing problems in a clean room in practice is in the order of several tens of μg/m³, an ammonia concentration of 240 of μg/m³ was used in the accelerated test. The results are shown in FIG. 5. The life of the chemical filter was 1100 hours. The period of time elapsed up to the time when the ammonia removal rate was decreased to as low as 90% was regarded as the life of the chemical filter. The pressure loss of the chemical filter determined under these conditions was 27 Pa. The results are shown in Table 1.

Test Conditions

Composition of feed gas: air containing 240 μg/m³ of ammonia

Temperature and humidity of the feed gas: 23° C., 50% RH

Target gas to be removed: ammonia

Gas feed rate: 0.5 m/sec

Thickness of chemical filter: 40 mm

### Comparative Example 1

A commercially available chemical filter (pitch: 3.3 mm, mountain height: 1.1 mm) with a size of 100 mm (length)×100 mm (width)×40 mm (thickness), prepared from a flat fibrous paper similar to a filter paper, which was prepared from a multiple center island-type ion-exchange fiber containing cation-exchange groups (ion-exchange capacity: 3.5 meq/g) and heat-sealed fiber by paper milling, by corrugating the flat fibrous paper into a waveform fibrous paper and laminating the waveform fibrous paper with the flat fibrous paper by alternately superposing them, was used. The ion exchange capacity per unit volume of the chemical filter was 700 eq/M³ and the amount of the ion-exchange fiber per unit volume of the chemical filter was 200 kg/m³.

The change in the ammonia removal rate over time and the life of the chemical filter were determined under the same conditions used in Example 1. The results are shown in FIG. 5. The life of the chemical filter was 900 hours. The pressure loss of the chemical filter determined in the same manner as in Example 1 was 27 Pa. The results are shown in Table 1.

### Comparative Example 2

A commercially available chemical filter (length: 100 mm, width: 100 mm, thickness: 45 mm) prepared by folding a non-woven fabric made from an organic polymer by irradiating the polymer with ionizing radiation followed by grafting cation-exchange groups (sulfonic acid groups, ion-exchange capacity: 3.0 meq/g) was used. The ion exchange capacity per unit volume of the chemical filter was 330 eq/m ³ and the amount of the ion-exchange fiber per unit volume of the chemical filter was 110 kg/M³.

The change in the ammonia removal rate over time and the life of the chemical filter were determined under the same conditions used in Example 1. The results are shown in FIG. 5. The life of the chemical filter was 550 hours. The pressure loss of the chemical filter determined in the same manner as in Example 1 was 53 Pa. The results are shown in Table 1.

### Comparative Example 3

A commercially available honeycomb chemical filter (length: 100 mm, width: 100 mm, thickness: 40 mm) prepared from activated carbon fiber to which phosphoric acid was attached was used.

The change in the ammonia removal rate over time and the life of the chemical filter were determined under the same conditions as used in Example 1. The results are shown in FIG. 5. The life of the chemical filter was 300 hours. The pressure loss of the chemical filter determined in the same manner as in Example 1 was 20 Pa. The results are shown in Table 1.

TABLE 1

| | Example | Comparative | Comparative | Comparative |
|---|---|---|---|---|
| | 1 | Example 1 | Example 2 | Example 3 |
| Ion exchange | 900 | 700 | 330 | — |
| capacity per | | | | |
| unit volume | | | | |
| (eq/m³) | | | | |
| Amount of ion | fiber: | 200 | 110 | — |
| exchanger per | 60 | | | |
| unit volume | resin: | | | |
| (kg/m³) | 156 | | | |
| Life of | 1100 | 900 | 550 | 300 |
| chemical | | | | |
| filter | | | | |
| (hours) | | | | |
| Pressure loss | 27 | 27 | 53 | 20 |
| (Pa) | | | | |

1. A method for manufacturing a chemical filter with a corrugated honeycomb structure, comprising coating or impregnating a fibrous paper containing ion-exchange fiber with a slurry mixture of an ion-exchange resin powder and an adhesive to obtain a paper supporting ion-exchange resin powder and applying the paper supporting ion-exchange resin powder to a corrugating process.

2. The method according to claim 1, wherein the slurry mixture is applied to both sides of the fibrous paper containing ion-exchange fiber.

3. The method according to claim 1, wherein the fibrous paper contains the ion-exchange fiber in an amount of 20-80%.

4. The method according to claim 1, wherein the ion-exchange capacity of the ion-exchange fiber is 1-5 meq/g.

5. The method according to claim 1, wherein the ion-exchange fiber contains at least a cation-exchange fiber or an anion-exchange fiber.

6. The method according to claim 1, wherein the average particle diameter of the ion-exchange resin powder particles is 1-150 μm.

7. The method according to claim 1, wherein the ion-exchange capacity of the ion-exchange resin powder is 1-10 meq/g.

8. The method according to claim 1, wherein the ion-exchange resin powder contains at least a cation-exchange resin powder or an anion-exchange resin powder.

9. The method according to claim 1, wherein the adhesive comprises at least one of inorganic adhesives or organic adhesives.
